(19) United States
(12) Patent Application Publication
(10) Pub. No.: US 2010/0290948 A1
(43) Pub. Date: Nov. 18, 2010

(54) ABSORBENT ARTICLES CAPABLE OF INDICATING THE PRESENCE OF URINARY TRACT INFECTIONS

(76) Inventor: XUEDONG SONG, Alpharetta, GA (US)

Correspondence Address: DORITY & MANNING, P.A., POST OFFICE BOX 1449, GREENVILLE, SC, 29602-1449, US

(21) Appl. No.: 12/466,735

(22) Filed: May 15, 2009

(51) Int. Cl. G01N 31/22

(52) U.S. Cl. 422/56

(57) ABSTRACT

In accordance with one embodiment of the present disclosure, a diagnostic test kit for detecting the presence or absence of nitrites within a test sample is disclosed. The test kit comprises an aromatic primary amine that is capable of reacting with a nitrite to form a diazonium ion. The test kit also comprises a lateral flow device that comprises a chromatographic medium and an absorbent material that receives the test sample after flowing through the chromatographic medium. The chromatographic medium defines a detection zone within which is contained a detection reagent consisting of a nucleophilic aromatic amine that is directly bound through covalent bonding to the chromatographic medium. The detection reagent is capable of reacting with the diazonium ion to form an indicator (e.g., azo compound). The indicator exhibits a color that is different than the color of the detection reagent.

### BACKGROUND

One of the most common bacterial infections is that of the urinary tract. Patients who need rapid diagnosis of urinary tract infections (UTIs) include premature newborn infants, prepubertal girls and young boys, sexually active women, elderly males and females, pre-operative patients, patients with chronic disease, patients with neurological disorders, patients with genitourinary congenital disorders including urethral valves and reflux, patients with sickle cell disease, patients with renal disease and polycystic kidney disease, patients having undergone renal transplantation and pregnant patients. The diagnosis of UTI in the elderly and in infants, in particular, is difficult because of different signs and symptoms and the inability to communicate.

One technique for diagnosing UTI involves measuring the level of nitrites in urine in particular, many bacteria, such as E. coli (the most common bacterium causing urinary tract infection), contain an enzyme that reduces nitrate ions (NO₃⁻) to nitrite ions (NO₂⁻). Vesical urine of most healthy persons is free from bacteria and as such, the detection of nitrite in urine may be used to help diagnose urinary tract infection. Several methods have been developed for assessment of nitrites. For example, dipsticks based on detection of nitrites have been developed that contain an area predisposed with reagents. The test sample is spotted onto the area so that the nitrites react with the reagents, thereby inducing a color change. Unfortunately, such test methods generally require a controlled reading window. However, it is not always feasible to carefully monitor testing, particularly in consumer-based applications.

In this regard, the present inventor has previously described improved techniques for detecting nitrites in a test sample in U.S. application Ser. No. 11/217,099, incorporated by reference herein. In particular, the previously described methods immobilized a detection reagent using a macromolecular moiety or other carrier material that bound the detection reagent to the substrate. However, while such techniques have been demonstrated to work well in absorbent products, further improvements are still needed.

As such, a need exists for an improved nitrite detection device. An absorbent article that incorporates such a device would be particularly beneficial.

### SUMMARY

In accordance with one embodiment of the present disclosure, a diagnostic test kit for detecting the presence or absence of nitrites within a test sample is disclosed. The test kit comprises an aromatic primary amine that is capable of reacting with a nitrite to form a diazonium ion. The test kit also comprises a lateral flow device that comprises a chromatographic medium and an absorbent material that receives the test sample after flowing through the chromatographic medium. The chromatographic medium defines a detection zone within which is contained a detection reagent consisting of a nucleophilic aromatic amine that is directly bound through covalent bonding to the chromatographic medium. The detection reagent is capable of reacting with the diazonium ion to form an indicator (e.g., azo compound). The indicator exhibits a color that is different than the color of the detection reagent.

In accordance with another embodiment of the present disclosure, an absorbent article capable of indicating the presence of urinary tract infections is provided. The absorbent article includes a substantially liquid impermeable layer, a liquid permeable layer, an absorbent core positioned between the substantially liquid impermeable layer and the liquid permeable layer, and a lateral flow device integrated into the article and positioned such that the device is in fluid communication with the urine when provided by a wearer of the article. The lateral flow device comprises a chromatographic medium and an absorbent material that receives the test sample after flowing through the chromatographic medium. The chromatographic medium defines a detection zone within which is contained a detection reagent consisting of a nucleophilic aromatic amine that is directly bound through covalent bonding to the chromatographic medium. The detection reagent is capable of reacting with the diazonium ion to form an indicator (e.g., azo compound). The indicator exhibits a color that is different than the color of the detection reagent.

Other features and aspects of the present disclosure are discussed in greater detail below.

### BRIEF DESCRIPTION OF THE DRAWINGS

A full and enabling disclosure of the present disclosure, including the best mode thereof, directed to one of ordinary skill in the art, is set forth more particularly in the remainder of the specification, which makes reference to the appended figure in which:

FIG. 1 is a perspective view of one embodiment of a lateral flow device that may be used in the present disclosure.

FIG. 2 is a perspective view of one embodiment of a device that can be used in the present disclosure.

Repeat use of reference characters in the present specification and drawings is intended to represent same or analogous features or elements of the disclosure.

### DETAILED DESCRIPTION OF REPRESENTATIVE EMBODIMENTS

### Definitions

As used herein, the term “test sample” generally refers to any material suspected of containing nitrites. The test sample may be derived from any biological source, such as a physiological fluid, including, blood, interstitial fluid, saliva, ocular lens fluid, cerebral spinal fluid, sweat, urine, milk, ascites fluid, mucous, nasal fluid, sputum, synovial fluid, peritoneal fluid, vaginal fluid, menses, amniotic fluid, semen, and so forth. Besides physiological fluids, other liquid samples may be used such as water, food products, and so forth, for the performance of environmental or food production assays. In addition, a solid material suspected of containing nitrites may be used as the test sample. The test sample may be used directly as obtained from the biological source or following a pretreatment to modify the character of the sample. For example, such pretreatment may include preparing plasma from blood, diluting viscous fluids, and so forth. Methods of pretreatment may also involve filtration, precipitation, dilution, distillation, mixing, concentration, inactivation of interfering components, the addition of reagents, lysing, etc. Moreover, it may also be beneficial to modify a solid test sample to form a liquid medium or to release the nitrites.

### Detailed Description

Reference now will be made in detail to various embodiments of the invention, one or more examples of which are set forth below. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention covers such modifications and variations as come within the scope of the appended claims and their equivalents.

The present disclosure is directed to a device for detecting the presence of nitrites in a test sample. In particular, the present disclosure describes a detection reagent consisting of a nucleophilic aromatic amine that is directly covalently bound to a chromatographic medium. Such a detection reagent can prevent leaching which is a safety concern.

Turning to the mechanism of detection of nitrites, a variety of reagents are used to accomplish the detection of nitrites. For example, aromatic primary amines may be employed that have the ability to react with nitrite ions under certain conditions. Aromatic primary amines are amines in which at least one primary amino group is connected to an aromatic ring. Aromatic primary amines may, for instance, have the following formula:

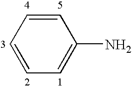

wherein positions 1 through 5 may be unsubstituted or substituted with a moiety, such as alkyl, alkylene, halogen, phenyl, hydroxyl, amino, amide, carboxyl, sulfonic, aromatic amine, aromatic amide, and other moieties. Particularly desired aromatic primary amines are those that are able to readily react with nitrite ions (or nitrous acid). Exemplary aromatic primary amines may include, for instance, aniline; 4-chloroaniline; 4-bromoaniline; 2,4,6-tribromoaniline; 2,4,6-trichloroaniline; α-trifluoro-m-toluidene; ortho-toluidine; m- and p-aminophenol; ortho-tolidine; sulfanilamide, p-aminobenzoic acid; 1-amino-8-hydroxynaphthalene-3,6-disulphonic acid; aminoacetoanilide; aminophenyl ether, p-arsalinic acid; 4-amino-1-naphthalenecarbonitrile; derivatives thereof; and so forth.

As stated, the aromatic primary amine is generally capable of reacting with nitrite ions (“nitrites”) under certain conditions. For instance, under acidic conditions, the nitrite ions form nitrous acid (nitric (III) acid), which has the formula HNO₂. Nitrous acid subsequently reacts with the aromatic primary amine to produce a diazonium ion having the following generic formula:

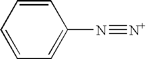

The diazonium ion may be zwitterionic in that the counterion of the diazonium moiety is covalently bound to the ring system. The ring system of the diazonium ion may be substituted or unsubstituted. Suitable diazonium salts that contain diazonium ions may include, for instance, diazonium chlorides, diazonium acid sulphates, diazonium alkyl sulphates, diazonium fluoborates, diazonium benzenesulphonates, diazonium acid 1,5-naphthalenedisulphonates, and so forth. Specific examples of diazonium salts are 1-diazo-2-naphthol-4-sulfonate; 1-diazophenyl-3-carbonate; 4-diazo-3-hydroxy-1-naphthylsulfonate (DNSA); 4-diazo-3-hydroxy-7-nitro-1-naphthylsulfonate (NDNSA); 4-diazo-3-hydroxy-1,7-naphthyldisulfonate; 2-methoxy-4-(N-morpholinyl) benzene diazonium chloride; 4-diazo-3-hydroxy-7-bromo-1-naphthylsulfonate; 4-diazo-3-hydroxy-7-[1,oxopropyl]-1-naphthylsulfonate; and derivatives thereof. Other suitable diazonium ions may be described in U.S. Pat. No. 4,637,979 to Skiold, et al.; U.S. Pat. No. 4,806,423 to Hugl, et al.; and U.S. Pat. No. 4,814,271 to Hugl, et al., which are incorporated herein in their entirety by reference thereto for all purposes. For instance, sulfanilamide (“SAA”) may react with nitrous acid to form a diazonium ion as follows:

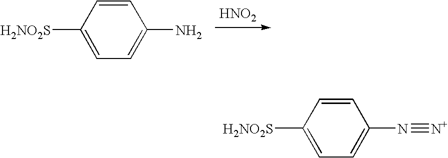

The resulting diazonium ion is an intermediate that is subsequently able to react with a detection reagent. The detection reagent is a nucleophilic (i.e., electron-rich) aromatic amine. Examples of such nucleophilic aromatic amines include, for instance, 8-hydroxyjulolidine, N,N-dimethylaniline; methylenedianiline; benzidine; benzoquinoline; aminoquinoline; m-phenylenediamine; α-trifluoro-m-toluidene; ortho-toluidine; m-aminophenol; ortho-tolidine; derivatives thereof; and so forth. One particularly suitable nucleophilic aromatic amine is N-1-naphthylethylene diamine (“NED”), which has the following structure:

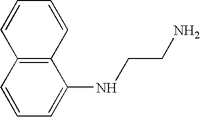

Previously, certain macromolecular reagents (e.g., polymers, oligomers, dendrimers, particles, etc.) were utilized as an anchoring carrier to reduce the diffusion of the detection reagent on a porous substrate. Such macromolecular reagents contained at least two functionalities, i.e., a reactive moiety and a macromolecular moiety, which were covalently or noncovalently joined. The carrier-bound detection reagent could be immobilized through either physical absorption or covalent bonding on a porous substrate

In accordance with the present disclosure, the substrate material is first chemically modified to create functional groups so that such functional groups can covalently bond with the detection reagent directly. For instance, cellulose-based filter paper can be first oxidized to create aldehyde functional groups that can directly react with an amino group of a detection reagent to form a Schiff base that is then reduced to form a stable amine bond that covalently attaches the detection reagent to the substrate material. As used herein, the term “amine bond” refers to any bond formed between an amine group (i.e., a chemical group derived from ammonia by replacement of one or more of its hydrogen atoms by hydrocarbon groups) and another atom or molecule.

For instance, covalent attachment of the detection reagent to a substrate may be accomplished using carboxylic, amino, aldehyde, bromoacetyl, iodoacetyl, thiol, epoxy or other reactive functional groups, as well as residual free radicals and radical cations, through which a coupling reaction may be accomplished. In this manner, the detection reagent is capable of direct covalent bonding to a substrate without the need for further modification.

In one embodiment, N-(1-naphthyl)ethylenediamine is covalently joined to a cellulosic substrate by the following mechanism.

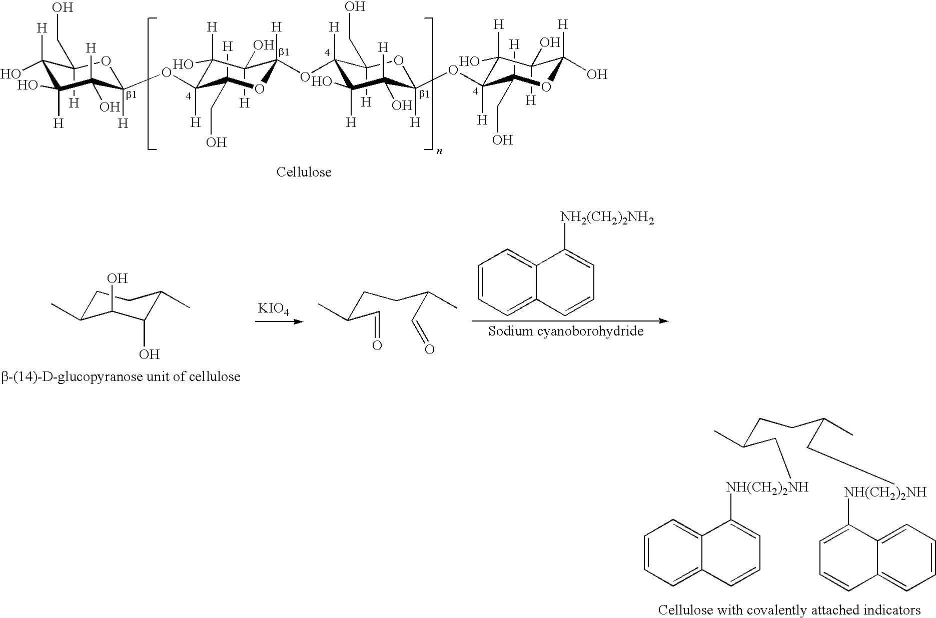

One particular technique for covalently bonding an aromatic amine to a substrate will now be described in more detail. In this particular embodiment, the aromatic amine moiety is formed from N-(1-naphthyl)ethylenediamine (“NED”). To covalently conjugate the substrate with the aromatic amine, the substrate is functionalized with potassium metal periodate (KlO₄) to create aldehyde functional groups, and the aldehyde groups may then be reacted with the primary amine (−NH₂) group of NED to form a Schiff base. The Schiff base is then reduced with sodium cyanoborohydride to form a stable amine bond that covalently attaches the detection reagent to the substrate material. However, any suitable reducing agent can be utilized in connection with the present disclosure.

Regardless of the particular detection reagent selected, the intermediate compound formed by the initial nitrite reaction may subsequently react with the detection reagent to form an indicator having a different color. For example, a diazonium ion formed in the reaction between a nitrite and aromatic primary amine may electrophilically attack the nucleophilic or “electron-rich” ring system of a nucleophilic aromatic amine detection reagent. This reaction is often referred to as “coupling” and results in the formation of an aromatic azo indicator having the generic formula, R—N═N—R′, wherein “R” and “R′” are aryl groups. In one embodiment, for example, a N-1-naphthylethylene diamine detection reagent reacts with a diazonium ion to form an azo indicator according to the following reaction:

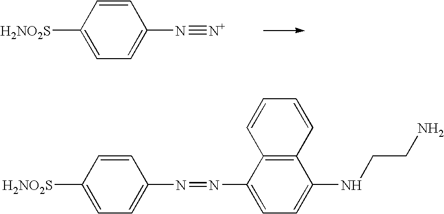

Without intending to be limited by theory, it is believed that this reaction induces either a shift of the absorption maxima towards the red end of the spectrum (“bathochromic shift”) or towards the blue end of the spectrum (“hypsochromic shift”). The type of absorption shift depends on the nature of the resulting azo molecule and whether it functions as an electron acceptor (oxidizing agent), in which a hypsochromic shift results, or whether it functions as an electron donor (reducing agent), in which a bathochromic shift results. Regardless, the absorption shift provides a color difference that is detectable, either visually or through instrumentation, to indicate the presence of nitrites within the test sample. For example, prior to contact with an infected test sample, the detection reagent may be colorless or it may possess a certain color. However, after reacting with the intermediate diazonium ion formed by the nitrite reaction described above, an aromatic azo indicator will form that exhibits a color that is different than the initial color of the detection reagent. Exemplary aromatic azo indicators that may be formed include dimethyidiazene, diphenydiazene, 1-naphthyl-2-naphthyl diazene, 3-chlorophenyl-4-chlorophenyl diazene, methylvinyl diazene, and 2-naphthylphenyl diazene.

As a result of the color change, the presence of nitrites in the test sample may be readily detected. The extent of the color change may be selectively controlled in accordance with the present disclosure to limit “false positives.” More specifically, the aromatic amines may undergo an oxidation reaction if left in air or other oxidizing environment for too great a period of time. The resulting oxidized compounds may possess a certain color that indicates a “false positive” or at the very least, adversely affect the ability to semi-quantitatively or quantitatively determine the presence of the nitrites. Thus, the present inventors have discovered a technique for reducing the problem of such “false positives.” Instead of simply measuring the results after a certain period of time, the desired reaction time may be achieved by selectively controlling the medium in which the reaction occurs. That is, the reaction medium is chromatographic in nature such that the reagents are allowed to flow in a consistent and controllable manner. While flowing through the medium, the aromatic primary amines and nitrites react to release a diazonium ion that subsequently couples with a nucleophilic aromatic amine detection reagent to form an aromatic azo compound. The aromatic azo indicator is immobilized within a discrete detection region for analysis. Due to the nature of the controlled fluid flow, any unreacted reagents travel to the end of the reaction medium so that they are unable to adversely interfere with observance of the aromatic azo compound in the detection region. Thus, to the extent that subsequent oxidation of aromatic compounds that are not captured at the detection region, the resulting color change will not occur within the detection region.

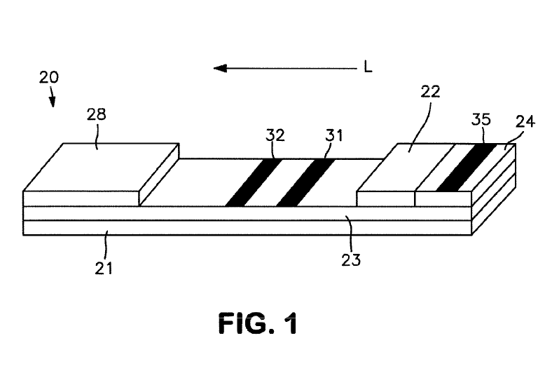

Various embodiments for accomplishing the detection of the nitrites using fluid flow control techniques will now be described in more detail. Referring to FIG. 1, for instance, one embodiment of a lateral flow device 20 that may be formed according to the present disclosure will now be described in more detail. As shown, the device 20 contains a chromatographic medium 23 optionally supported by a rigid support material 21. In general, the chromatographic medium 23 may be made from any of a variety of materials through which the test sample is capable of passing. For example, the chromatographic medium 23 may be a porous membrane formed from synthetic or naturally occurring materials, such as polysaccharides (e.g., cellulose materials such as paper and cellulose derivatives, such as cellulose acetate and nitrocellulose); polyether sulfone; polyethylene; nylon; polyvinylidene fluoride (PVDF); polyester; polypropylene; silica; inorganic materials, such as deactivated alumina, diatomaceous earth, MgSO₄, or other inorganic finely divided material uniformly dispersed in a porous polymer matrix, with polymers such as vinyl chloride, vinyl chloride-propylene copolymer, and vinyl chloride-vinyl acetate copolymer; cloth, both naturally occurring (e.g., coffon) and synthetic (e.g., nylon or rayon); porous gels, such as silica gel, agarose, dextran, and gelatin; polymeric films, such as polyacrylamide; and so forth. In one particular embodiment, the chromatographic medium 23 is formed from nitrocellulose and/or polzyether sulfone materials. It should be understood that the term “nitrocellulose” refers to nitric acid esters of cellulose, which may be nitrocellulose alone, or a mixed ester of nitric acid and other acids, such as aliphatic carboxylic acids having from 1 to 7 carbon atoms.

The size and shape of the chromatographic medium 23 may generally vary as is readily recognized by those skilled in the art. For instance, a porous membrane strip may have a length of from about 10 to about 100 millimeters, in some embodiments from about 20 to about 80 millimeters, and in some embodiments, from about 40 to about 60 millimeters. The width of the membrane strip may also range from about 0.5 to about 20 millimeters, in some embodiments from about 1 to about 15 millimeters, and in some embodiments, from about 2 to about 10 millimeters. Likewise, the thickness of the membrane strip is generally small enough to allow transmission-based detection. For example, the membrane strip may have a thickness less than about 500 micrometers, in some embodiments less than about 250 micrometers, and in some embodiments, less than about 150 micrometers.

As stated above, the support 21 carries the chromatographic medium 23. For example, the support 21 may be positioned directly adjacent to the chromatographic medium 23 as shown in FIG. 1, or one or more intervening layers may be positioned between the chromatographic medium 23 and the support 21. Regardless, the support 21 may generally be formed from any material able to carry the chromatographic medium 23. The support 21 may be formed from a material that is transmissive to light, such as transparent or optically diffuse (e.g., transluscent) materials. Also, it is generally desired that the support 21 is liquid-impermeable so that fluid flowing through the medium 23 does not leak through the support 21. Examples of suitable materials for the support include, but are not limited to, glass; polymeric materials, such as polystyrene, polypropylene, polyester (e.g., Mylar® film), polybutadiene, polyvinylchloride, polyamide, polycarbonate, epoxides, methacrylates, and polymelamine; and so forth. To provide a sufficient structural backing for the chromatographic medium 23, the support 21 is generally selected to have a certain minimum thickness. Likewise, the thickness of the support 21 is typically not so large as to adversely affect its optical properties. Thus, for example, the support 21 may have a thickness that ranges from about 100 to about 5,000 micrometers, in some embodiments from about 150 to about 2,000 micrometers, and in some embodiments, from about 250 to about 1,000 micrometers. For instance, one suitable membrane strip having a thickness of about 125 micrometers may be obtained from Millipore Corp. of Bedford, Mass. under the name “SHF180UB25.”

As is well known the art, the chromatographic medium 23 may be cast onto the support 21, wherein the resulting laminate may be die-cut to the desired size and shape. Alternatively, the chromatographic medium 23 may simply be laminated to the support 21 with, for example, an adhesive. In some embodiments, a nitrocellulose or nylon porous membrane is adhered to a Mylar® film. An adhesive is used to bind the porous membrane to the Mylar® film, such as a pressure-sensitive adhesive. Laminate structures of this type are believed to be commercially available from Millipore Corp. of Bedford, Mass. Still other examples of suitable laminate device structures are described in U.S. Pat. No. 5,075,077 to Durley, III, et al., which is incorporated herein in its entirety by reference thereto for all purposes.

As discussed above, the portion of the chromatographic medium containing the detection reagent must first be chemically modified to create functional groups so that such functional groups can covalently bond with the detection reagent directly. In this regard, such portion of the chromatographic medium can be modified prior to application of the detection reagent. This portion can be prepared separately from the other portions of the chromatographic medium, and then placed in fluid communication with the other portions.

The device 20 also contains an absorbent material 28 that is positioned adjacent to the medium 23. The absorbent material 28 assists in promoting capillary action and fluid flow through the medium 23. In addition, the absorbent material 28 receives fluid that has migrated through the entire chromatographic medium 23 and thus draws any unreacted components away from the detection region to help reduce the likelihood of “false positives.” Some suitable absorbent materials that may be used in the present disclosure include, but are not limited to, nitrocellulose, cellulosic materials, porous polyethylene pads, glass fiber filter paper, and so forth. The absorbent material may be wet or dry prior to being incorporated into the device. Pre-wetting may facilitate capillary flow for some fluids, but is not typically required. Also, as is well known in the art, the absorbent material may be treated with a surfactant to assist the wicking process.

To initiate the detection of nitrites within the test sample, a user may directly apply the test sample to a portion of the chromatographic medium 23 through which it may then travel in the direction illustrated by arrow “L” in FIG. 1. Alternatively, the test sample may first be applied to a sample application zone 24 that is in fluid communication with the chromatographic medium 23. The sample application zone 24 may be formed on the medium 23. Alternatively, as shown in FIG. 1, the sample application zone 24 may be formed by a separate material, such as a pad. Some suitable materials that may be used to form such sample pads include, but are not limited to, nitrocellulose, cellulose, porous polyethylene pads, and glass fiber filter paper. If desired, the sample application zone 24 may also contain one or more pretreatment reagents, either diffusively or non-diffusively attached thereto. In the illustrated embodiment, the test sample travels from the sample application zone 24 to a coupling zone 22 that is in communication with the sample application zone 24. As described above, the coupling zone 22 may be formed on the medium 23. Alternatively, as shown in FIG. 1, the coupling zone 22 is from a separate material or pad. Such a coupling pad may be formed from any material through which the test sample is capable of passing, such as glass fibers.

To facilitate detection of nitrites in the manner described above, an aromatic primary amine is employed. In some embodiments, the aromatic primary amine may be mixed with the test sample prior to application to the device 20. Alternatively, the aromatic primary amine may be diffusively immobilized on the device 20 prior to application of the test sample. Such pre-application provides a variety of benefits, including the elimination of the need for a subsequent user to handle and mix the reagents with the test sample or a diluent. This is particularly useful in point-of-care applications when the user is not generally a trained lab technician or medical professional. The aromatic primary amine may be disposed downstream from the sample application zone 24. In this manner, the test sample is capable of mixing with the nitrites upon application. Alternatively, the aromatic primary amine may be positioned upstream from the sample application zone 24. For instance, a diluent may be employed to induce mixing between the aromatic primary amine and test sample.

If desired, the pH may be maintained at an acidic level to facilitate the desired nitrite reaction, such as described above. For instance, the pH is typically maintained at a level of less than about 6, and in some embodiments, from about 1 to about 4. To accomplish the desired pH level, a variety of techniques may be employed. For instance, an aromatic primary amine may be selected that is relatively acidic, such as p-arsalinic acid. Alternatively, an acidic pH modifier may be mixed with the aromatic primary amine prior to application to the device 20, mixed with the test sample, or both. The pH modifier may also be separately applied to the lateral flow device 20 so that it is capable of mixing with the reagents upon application to the test sample. Some examples of acidic pH modifiers that may be used in the present disclosure include, but are not limited to, mineral acids, sulfonic acids (e.g., 2-[N-morpholino] ethane sulfonic acid (“MES”), carboxylic acids, and polymeric acids. Specific examples of suitable mineral acids are hydrochloric acid, nitric acid, phosphoric acid, and sulfuric acid. Specific examples of suitable carboxylic acids are citric acid, glycolic acid, lactic acid, acetic acid, maleic acid, gallic acid, malic acid, succinic acid, glutaric acid, benzoic acid, malonic acid, salicylic acid, gluconic acid, and mixtures thereof. Specific examples of suitable polymeric acids include straight-chain poly(acrylic) acid and its copolymers (e.g., maleic-acrylic, sulfonic-acrylic, and styrene-acrylic copolymers), cross-linked polyacrylic acids having a molecular weight of less than about 250,000, poly(methacrylic) acid, and naturally occurring polymeric acids such as carageenic acid, carboxymethyl cellulose, and alginic acid.

Referring again to FIG. 1, the lateral flow device 20 includes a detection zone 31 within which is immobilized a detection reagent (e.g., nucleophilic aromatic amine). The detection reagent is applied directly to the medium 23 and can first be formed into a solution prior to application. Various solvents may be utilized to form the solution, such as, but not limited to, acetonitrile, dimethylsulfoxide (DMSO), ethyl alcohol, dimethylformamide (DMF), and other polar organic solvents. The amount of the detection reagent in the solution may range from about 0.001 to about 100 milligrams per milliliter of solvent, and in some embodiments, from about 0.1 to about 10 milligrams per milliliter of solvent. In one particular embodiment, the detection zone 31 is defined by the chromatographic medium 23 and formed by coating a solution thereon using well-known techniques and then dried. The detection reagent concentration may be selectively controlled to provide the desired level of detection sensitivity.

Typically, it is desired that the detection reagent be applied in a manner so that it does not substantially diffuse through the matrix of the chromatographic medium 23 (i.e., non-diffusively immobilized). This enables a user to readily detect the change in color that occurs upon reaction of the detection reagent with the intermediate diazonium ion. The detection reagent forms a direct covalent bond with functional groups present on the surface of the chromatographic medium 23 so that it remains immobilized thereon.

One benefit of the lateral flow device of the present disclosure is its ability to readily incorporate one or more additional reagent zones to facilitate the above-described reaction. For example, referring again to FIG. 1, one such zone is a quenching zone 35. The quenching zone 35 is configured to remove compounds from the test sample that would otherwise interfere with the accuracy of the detection system. For example, contaminants (e.g., phenolics, bilirubin, urobilinogen, etc.) within the test sample may react with the intermediate diazonium ions to form aromatic azo compounds, thereby producing a “false negative” result. Thus, the quenching zone 35 may contain a quenching agent, such as a diazonium ion, that is capable of reacting with the reaction contaminants. Typically, the quenching agent is non-diffusively immobilized within the quenching zone 35 in the manner described above so that it does not flow through the medium 23 and interfere with testing. The location of the quenching zone 35 may vary, but is typically positioned upstream from the detection zone 31 and the coupling zone 22 to avoid interference with nitrite detection. For example, in the illustrated embodiment, the quenching zone 35 is positioned between the sample application zone 24 and the coupling zone 22. Alternatively, the quenching zone 35 may be positioned upstream from the sample application zone 24.

Another zone that may be employed in the lateral flow device 20 for improving detection accuracy is a control zone 32. The control zone 32 gives a signal to the user that the test is performing properly. More specifically, control reagents may be employed that flow through the chromatographic medium 23 upon contact with a sufficient volume of the test sample. These control reagents may then be observed, either visually or with an instrument, within the control zone 32. The control reagents generally contain a detectable substance, such as luminescent compounds (e.g., fluorescent, phosphorescent, etc.); radioactive compounds; visual compounds (e.g., colored dye or metallic substance, such as gold); liposomes or other vesicles containing signal-producing substances; enzymes and/or substrates, and so forth. Other suitable detectable substances may be described in U.S. Pat. No. 5,670,381 to Jou, et al. and U.S. Pat. No. 5,252,459 to Tarcha, et al., which are incorporated herein in their entirety by reference thereto for all purposes. If desired, the detectable substances may be disposed on particles such as described above. For example, latex particles may be utilized that are labeled with a fluorescent or colored dye. Commercially available examples of suitable fluorescent particles include fluorescent carboxylated microspheres sold by Molecular Probes, Inc. under the trade names “FluoSphere” (Red 580/605) and “TransfluoSphere” (543/620), as well as “Texas Red” and 5- and 6-carboxytetramethylrhodamine, which are also sold by Molecular Probes, Inc. In addition, commercially available examples of suitable colored, latex microparticles include carboxylated latex beads sold by Bang's Laboratory, Inc.

The location of the control zone 32 may vary based on the nature of the test being performed. In the illustrated embodiment, for example, the control zone 32 is defined by the chromatographic medium 23 and positioned downstream from the detection zone 31. In such embodiments, the control zone 32 may contain a material that is non-diffusively immobilized in the manner described above and forms a chemical and/or physical bond with the control reagents. When the control reagents contain latex particles, for instance, the control zone 32 may include a polyelectrolyte that binds to the particles. Various polyelectrolytic binding systems are described, for instance, in U.S. Patent App. Publication No. 2003/0124739 to Song, et al., which is incorporated herein in it entirety by reference thereto for all purposes. In alternative embodiments, however, the control zone 32 may simply be defined by a region of the absorbent material 28 to which the control reagents flow after traversing through the chromatographic medium 23.

Regardless of the particular control technique selected, the application of a sufficient volume of the test sample to the device 20 will cause a signal to form within the control zone 32, whether or not nitrites are present. Among the benefits provided by such a control zone is that the user is informed that a sufficient volume of test sample has been added without requiring careful measurement or calculation. This provides the ability to use the lateral flow device 20 without the need for externally controlling the reaction time, test sample volume, etc.

The detection zone 31, quenching zone 35, control zone 32, and any other zone employed in the lateral flow device 20 may generally provide any number of distinct detection regions so that a user may better determine the concentration of nitrites within the test sample. Each region may contain the same or different materials. For example, the zones may include two or more distinct regions (e.g., lines, dots, etc.). The regions may be disposed in the form of lines in a direction that is substantially perpendicular to the flow of the test sample through the device 20. Likewise, in some embodiments, the regions may be disposed in the form of lines in a direction that is substantially parallel to the flow of the test sample through the device 20.

One particular embodiment of a method for detecting the presence of nitrites within a test sample using the device 20 of FIG. 1 will now be described in more detail. Initially, a test sample containing nitrites is applied to the sample application zone 24 and travels in the direction “L” to the coupling zone 22. At the coupling zone 22, the nitrites are able to mix and react with the aromatic primary amines. As the mixture flows through the device 20, the nitrites and aromatic primary amines react further to form intermediate diazonium ions. The diazonium ions then flow to the detection zone 31 where they react with a nucleophilic aromatic amine detection reagent to form a colored azo indicator. After the reaction, the detection zone 31 changes color. Thus, the color or color intensity of the detection zone 31 may be determined, either visually or with instrumentation. If desired, the intensity of the color at the detection zone 31 may be measured to quantitatively or semi-quantitatively determine the level of nitrites present in the test sample. The intensity of the color at the detection zone 31 is typically directly proportional to nitrite concentration. The intensity of the detection signal “Iₛ” produced at the detection zone 31 may also be compared to a predetermined detection curve developed for a plurality of known nitrite concentrations. To determine the quantity of nitrites in an unknown test sample, the signal may simply be converted to nitrite concentration according to the detection curve. Regardless, the unreacted reagents travel past the detection zone 31 until they reach the absorbent material 28. In some cases, the aromatic compounds will self-react over a period of time in air to form colored compounds. However, because such colored compounds are not located at the detection region 31, they generally do not interfere with the detection accuracy.

The present disclosure provides a relatively simple, compact and cost-efficient device for accurately detecting the presence of nitrites within a test sample (e.g., urine). The test result may be visible so that it is readily observed by the person performing the test in a prompt manner and under test conditions conducive to highly reliable and consistent test results.

In accordance with the present disclosure, one or more devices described herein can also be integrated into an absorbent article. An “absorbent article” generally refers to any article capable of absorbing water or other fluids. Examples of some absorbent articles include, but are not limited to, personal care absorbent articles, such as diapers, training pants, absorbent underpants, incontinence articles, feminine hygiene products (e.g., sanitary napkins), swim wear, baby wipes, and so forth; medical absorbent articles, such as garments, fenestration materials, underzones, bedzones, bandages, absorbent drapes, and medical wipes; food service wipers; clothing articles; and so forth. Materials and processes suitable for forming such absorbent articles are well known to those skilled in the art. Typically, absorbent articles include a substantially liquid-impermeable layer (e.g., outer cover), a liquid-permeable layer (e.g., bodyside liner, surge layer, etc.), and an absorbent core.

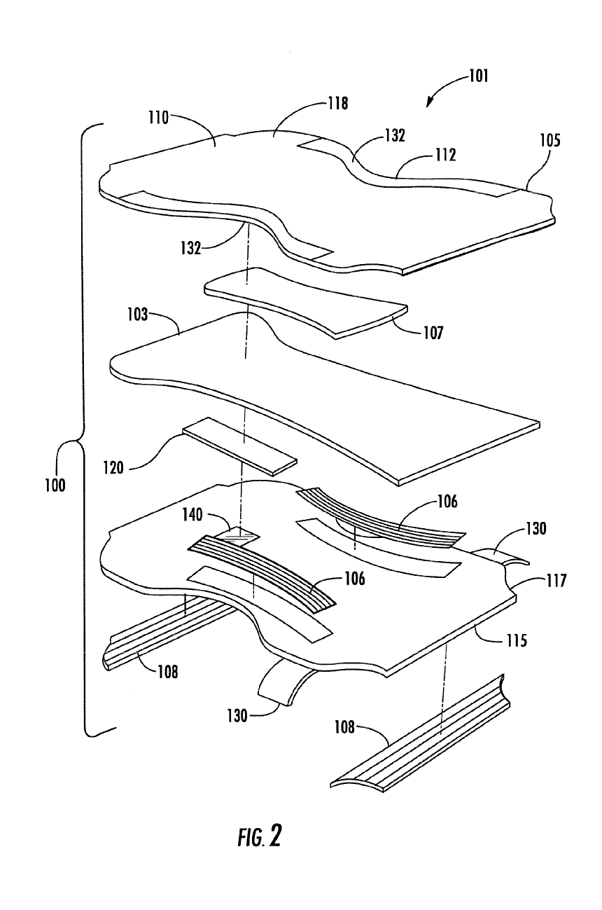

Various embodiments of an absorbent article that can be formed according to the present disclosure will now be described in more detail. For purposes of illustration only, as absorbent article is shown in FIG. 2 as a diaper 101. In the illustrated embodiment, the diaper 101 is shown as having an hourglass shape in an unfastened configuration. However, other shapes can of course be utilized, such as a generally rectangular shape, T-shape, or I-shape. As shown, the diaper 101 includes a chassis formed by various components, including an outer cover 117, bodyside liner 105, absorbent core 103, and surge layer 107. It should be understood, however, that other layers can also be used in exemplary embodiments of the present disclosure. Likewise, one or more of the layers referred to in FIG. 2 can also be eliminated in certain exemplary embodiments of the present disclosure.

The bodyside liner 105 is generally employed to help isolate the wearer's skin from liquids held in the absorbent core 103. For example, the liner 105 presents a bodyfacing surface that is typically compliant, soft feeling, and non-irritating to the wearer's skin. Typically, the liner 105 is also less hydrophilic than the absorbent core 103 so that its surface remains relatively dry to the wearer. As indicated above, the liner 105 can be liquid-permeable to permit liquid to readily penetrate through its thickness. Exemplary liner constructions that contain a nonwoven web are described in U.S. Pat. No. 5,192,606 to Proxmire, et al.; U.S. Pat. No. 5,702,377 to Collier, IV. et al.; U.S. Pat. No. 5,931,823 to Stokes, et al.; U.S. Pat. No. 6,060,638 to Paul, et al.; and U.S. Pat. No. 6,150,002 to Varona, as well as U.S. Patent Application Publication Nos. 2004/0102750 to Jameson; 2005/0054255 to Morman, et al.; and 2005/0059941 to Baldwin, et al., all of which are incorporated herein in their entirety by reference thereto for all purposes.

The diaper 101 can also include a surge layer 107 that helps to decelerate and diffuse surges or gushes of liquid that can be rapidly introduced into the absorbent core 103. Desirably, the surge layer 107 rapidly accepts and temporarily holds the liquid prior to releasing it into the storage or retention portions of the absorbent core 103. In the illustrated embodiment, for example, the surge layer 107 is interposed between an inwardly facing surface 116 of the bodyside liner 105 and the absorbent core 103. Alternatively, the surge layer 107 can be located on an outwardly facing surface 118 of the bodyside liner 105. The surge layer 107 is typically constructed from highly liquid-permeable materials. Examples of suitable surge layers are described in U.S. Pat. No. 5,486,166 to Bishop, et al. and U.S. Pat. No. 5,490,846 to Ellis, et al., which are incorporated herein in their entirety by reference thereto for all purposes.

The outer cover 117 is typically formed from a material that is substantially impermeable to liquids. For example, the outer cover 117 can be formed from a thin plastic film or other flexible liquid-impermeable material. In one embodiment, the outer cover 117 is formed from a polyethylene film having a thickness of from about 0.01 millimeter to about 0.05 millimeter. The film can be impermeable to liquids, but permeable to gases and water vapor (i.e., “breathable”). This permits vapors to escapee from the absorbent core 103, but still prevents liquid exudates from passing through the outer cover 117. If a more cloth-like feeling is desired, the outer cover 117 can be formed from a polyolefin film laminated to a nonwoven web. For example, a stretch-thinned polypropylene film can be thermally laminated to a spunbond web of polypropylene fibers.

Besides the above-mentioned components, the diaper 101 can also contain various other components as is known in the art. For example, the diaper 101 can also contain a substantially hydrophilic tissue wrapsheet (not illustrated) that helps maintain the integrity of the fibrous structure of the absorbent core 103. The tissue wrapsheet is typically placed about the absorbent core 103 over at least the two major facing surfaces thereof, and composed of an absorbent cellulosic material, such as creped wadding or a high wet-strength tissue. The tissue wrapsheet can be configured to provide a wicking layer that helps to rapidly distribute liquid over the mass of absorbent fibers of the absorbent core 103. The wrapsheet material on one side of the absorbent fibrous mass can be bonded to the wrapsheet located on the opposite side of the fibrous mass to effectively entrap the absorbent core 103. Furthermore, the diaper 101 can also include a ventilation layer (not shown) that is positioned between the absorbent core 103 and the outer cover 117. When utilized, the ventilation layer can help insulate the outer cover 117 from the absorbent core 103, thereby reducing dampness in the outer cover 117. Examples of such ventilation layers can include a nonwoven web laminated to a breathable film, such as described in U.S. Pat. No. 6,663,611 to Blaney, et al., which is incorporated herein in its entirety by reference thereto for all purposes.

In some embodiments, the diaper 101 can also include a pair of side panels (or ears) (not shown) that extend from the side edges 132 of the diaper 101 into one of the waist regions. The side panels can be integrally formed with a selected diaper component. For example, the side panels can be integrally formed with the outer cover 117 or from the material employed to provide the top surface. In alternative configurations, the side panels can be provided by members connected and assembled to the outer cover 117, the top surface, between the outer cover 117 and top surface, or in various other configurations. If desired, the side panels can be elasticized or otherwise rendered elastomeric by use of the elastic nonwoven composite of the present disclosure. Examples of absorbent articles that include elasticized side panels and selectively configured fastener tabs are described in PCT Patent Application WO 95/16425 to Roessler; U.S. Pat. No. 5,399,219 to Roessler et al.; U.S. Pat. No. 5,540,796 to Fries; and U.S. Pat. No. 5,595,618 to Fries, et al., each of which is incorporated herein in its entirety by reference thereto for all purposes.

As representatively illustrated in FIG. 2, the diaper 101 can also include a pair of containment flaps 112 that are configured to provide a barrier and to contain the lateral flow of body exudates. The containment flaps 112 can be located along the laterally opposed side edges 132 of the bodyside liner 105 adjacent the side edges of the absorbent core 103. The containment flaps 112 can extend longitudinally along the entire length of the absorbent core 103, or can only extend partially along the length of the absorbent core 103. When the containment flaps 112 are shorter in length than the absorbent core 103, they can be selectively positioned anywhere along the side edges 132 of diaper 101 in a crotch region 110. In one embodiment, the containment flaps 112 extend along the entire length of the absorbent core 103 to better contain the body exudates. Such containment flaps 112 are generally well known to those skilled in the art. For example, suitable constructions and arrangements for the containment flaps 112 are described in U.S. Pat. No.4,704,116 to Enloe, which is incorporated herein in its entirety by reference thereto for all purposes.

To provide improved fit and to help reduce leakage of body exudates, the diaper 101 can be elasticized with suitable elastic members, as further explained below. For example, as representatively illustrated in FIG. 2, the diaper 101 can include leg elastics 106 constructed to operably tension the side margins of the diaper 101 to provide elasticized leg bands which can closely fit around the legs of the wearer to reduce leakage and provide improved comfort and appearance. Waist elastics 108 can also be employed to elasticize the end margins of the diaper 101 to provide elasticized waistbands. The waist elastics 108 are configured to provide a resilient, comfortably close fit around the waist of the wearer.

The diaper 101 can also include one or more fasteners 130. For example, two flexible fasteners 130 are illustrated in FIG. 2 on opposite side edges of waist regions to create a waist opening and a pair of leg openings about the wearer. The shape of the fasteners 130 can generally vary, but can include, for instance, generally rectangular shapes, square shapes, circular shapes, triangular shapes, oval shapes, linear shapes, and so forth. The fasteners can include, for instance, a hook-and-loop material, buttons, pins, snaps, adhesive tape fasteners, cohesives, fabric-and-loop fasteners, etc. In one particular embodiment, each fastener 130 includes a separate piece of hook material affixed to the inside surface of a flexible backing.

The various regions and/or components of the diaper 101 can be assembled together using any known attachment mechanism, such as adhesive, ultrasonic, thermal bonds, etc. Suitable adhesives can include, for instance, hot melt adhesives, pressure-sensitive adhesives, and so forth. When utilized, the adhesive can be applied as a uniform layer, a patterned layer, a sprayed pattern, or any of separate lines, swirls or dots. In the illustrated embodiment, for example, the outer cover 117 and bodyside liner 105 are assembled to each other and to the absorbent core 103 using an adhesive. Alternatively, the absorbent core 103 can be connected to the outer cover 117 using conventional fasteners, such as buttons, hook and loop type fasteners, adhesive tape fasteners, and so forth. Similarly, other diaper components, such as the leg elastic members 106, waist elastic members 108 and fasteners 130, can also be assembled into the diaper 101 using any attachment mechanism.

Generally speaking, the devices of the present disclosure can be incorporated into the absorbent article in a variety of different orientations and configurations, so long as the device is capable of receiving urine and providing a signal to a user or caregiver of the UTI. For example, the sampling zone and control zone can be visible to the user or caregiver so that a simple, accurate, and rapid indication of UTI can be provided. The visibility of such layer(s) can be accomplished in a variety of ways. For example, in some embodiments, the absorbent article can include a transparent or translucent portion 140 (e.g., window, film, etc.) that allows the sampling zone and/or indicator zone to be readily viewed without removal of the absorbent article from the wearer and/or without disassembly of the absorbent article. In other embodiments, the sampling zone and/or indicator zone can extend through a hole or aperture in the absorbent article for observation. In still other embodiments, the sampling zone and/or indicator zone can simply be positioned on a surface of the absorbent article for observation.

Regardless of the particular manner in which it is integrated, urine can be directly discharged to a portion of the device, a liquid permeable cover or other material surrounding assay device 120, or can be discharged onto a component of the absorbent article into which the assay device 120 has been integrated.

After a sufficient reaction time, the intensity of the color can be measured to quantitatively or semi-quantitatively determine the presence of UTI. For example, a diaper having an integrated assay device can be periodically used as part of a monitoring program that tests for UTI. Upon indication of UTI, further quantitative testing can then be undertaken to determine the scope and stage of the problem detected so as to provide additional treatment information.

The present disclosure may be better understood with reference to the following examples.

### EXAMPLE 1

Preparation of reactive filter paper: 50 pieces of Whatman filter papers (11 cm in diameter) were soaked with potassium metal periodate (KlO₄) in 300 ml water overnight. The papers were extensively rinsed with water and air-dried.

### EXAMPLE2

Covalent attachment of NED to filter papers to make indicator sheets: 20 pieces of reactive filter papers were soaked in 1 g of N-(1-naphthyl)ethylenediamine (NED) chloride in water for half hour and then 1 g of NaBH(CN)₃ was added and the paper was continuously stirred overnight at room temperature. The filters were then rinsed first by water and then by methanol, and then air-dried. 7 mm wide strip was prepared from the filter paper to make an indicator zone.

### EXAMPLE 3

Covalent attachment of NED to Immunodyne or Ultrabinder Nylon membrane to make indicator sheets: 0.5 g of NED.HCl was added in 30 ml and a 10 cm×10 cm ultrabinder or immunodyne membrane was soaked and allowed to stay overnight. The membranes were rinsed with water and air-dried.

### EXAMPLE 4

Preparation of indicator sheets: One piece of the NED-attached filter paper (or NED attached ultrabinder or immunodyne) was added with 2 ml of 80 mg/ml oxalic acid (or citric acid) in methanol and air-dried. A second 2 ml oxalic acid solution (or citric acid) was added and air-dried. 7 mm wide strip was prepared from the filter paper to make an indicator zone.

### EXAMPLE 5

Preparation of coupler zone strip without acid: a 5 mm×30 mm glass fiber pad was soaked with 3.5 ml of SAA (5 mg/ml) and SDS (15 mg/ml) in methanol and air-dried.

### EXAMPLE 6

Preparation of coupler zone strip without acid: a 6 mm×30 mm cellulose pad was soaked with 4 ml of SM (5 mg/ml) and Tween 40 (10 mg/ml) in methanol and air-dried.

### EXAMPLE 7

Preparation of coupler zone strip with acid: a 5 mm×30 mm glass fiber pad (or cellulose pad) was soaked with 3.5 ml of SAA (5 mg/ml), citric acid (5 mg/ml) and SDS (15 mg/ml) in methanol and air-dried 8. Preparation of feedback sheets: 0.2 mg/ml bromocresol green in methanol was used to soak 10 cm×10 cm pieces of Biodyne Plus membrane and air-dried.

### EXAMPLE 8

Preparation of devices without a feedback zone: a strip of 6 mm×10 cm indicator strip was mounted on the middle of a plastic supporting card. A 10 cm long coupler pad was mounted at one side of the indicator strip with 1.5 mm overlap to make and a 10 cm long cellulose pad was mounted at the other side of the indicator strip with 1.5 mm overlap to make wicking zone. A third cellulose strip was mounted some degree of overlap with the coupler strip to make a sample zone. The whole card was then cut into 5 mm wide strips.

### EXAMPLE 9

Preparation of devices with a feedback zone: in addition to all the components in example 8, a strip of feedback sheet was mounted on the wicking zone strip through a transparent tape. The whole card was then cut into 5 mm wide strips.

### EXAMPLE 10

Detection of nitrite using the devices: 300 ul of urine samples with nitrite concentrations ranging from 0, 1, 2, 4, 8, 16 ug/ml in urine are added to each well of a microtiter plate. The sample zone of a device prepared in Example 8 or 9 was inserted into each well to allow the sample to flow to the devices. No color was observed in the detection zone for urine sample without nitrite while pink color was observed to develop for samples with nitrite. The feedback zone changes color from green to yellow upon wetting for all the samples.

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present disclosure can be practiced by those of ordinary skill in the art, without departing from the spirit and scope of the present disclosure, which is more particularly set forth in the appended claims. In addition, it should be understood that aspects of the various embodiments can be interchanged both in whole or in part. Furthermore, those of ordinary skill in the art will appreciate that the foregoing description is by way of example only, and is not intended to limit the disclosure so further described in such appended claims.

What is claimed is:

1. A diagnostic test kit for detecting the presence or absence of nitrites within a test sample, the test kit comprising:
an aromatic primary amine that is capable of reacting with a nitrite to form a diazonium ion; and
a lateral flow device that comprises:
a chromatographic medium defining a detection zone within which a detection reagent consisting of a nucleophilic aromatic amine is directly covalently bound to the chromatographic medium, the detection reagent being capable of reacting with the diazonium ion to form an indicator, the indicator exhibiting a color that is different than the color of the detection reagent; and
an absorbent material that receives the test sample after flowing through the chromatographic medium.

2. The diagnostic test kit of claim 1, wherein the aromatic primary amine comprises aniline; 4-chloroaniline; 4-bromoaniline; 2,4,6-tribromoaniline; 2,4,6-trichloroaniline; α-trifluoro-m-toluidene; ortho-toluidine; m- and p-aminophenol; ortho-tolidine; sulfanilamide, p-aminobenzoic acid; 1-amino-8-hydroxynaphthalene-3,6-disulphonic acid; aminoacetoanilide; aminophenyl ether, p-arsalinic acid; 4-amino-1-naphthalenecarbonitrile, or derivatives thereof.

3. The diagnostic test kit of claim 1, wherein the aromatic primary amine is p-arsalinic acid, sulfanilamide, or a derivative thereof.

4. The diagnostic test kit of claim 1, wherein the detection reagent comprises 8-hydroxyjulolidine, N,N-dimethylaniline; methylenedianiline; benzidine; benzoquinoline; aminoquinoline; m-phenylenediamine; α-trifluoro-m-toluidene; ortho-toluidine; m-aminophenol; ortho-tolidine; N-1-naphthylethylene diamine, or a derivative thereof.

5. The diagnostic test kit of claim 1, wherein the detection reagent comprises N-1-naphthylethylene diamine or a derivative thereof, and the detection reagent is attached to the chromatographic medium covalently by an amine bond

6. The diagnostic test kit of claim 1, wherein the indicator is an aromatic azo compound.

7. The diagnostic test kit of claim 1, wherein the chromatographic medium is a porous membrane.

8. The diagnostic test kit of claim 1, wherein the aromatic primary amine is disposed on the lateral flow assay device.

9. The diagnostic test kit of claim 8, wherein the lateral flow assay device further comprises a coupler zone within which is contained the aromatic primary amine.

10. The diagnostic test kit of claim 9, further comprising a sample application zone that is located upstream from the coupler zone.

11. The diagnostic test kit of claim 9, wherein the coupler zone further comprises a surfactant.

12. The diagnostic test kit of claim 1, wherein the lateral flow device comprises a control zone that is capable of signaling the presence of the test sample.

13. The diagnostic test kit of claim 1, wherein the test sample is urine.

14. An absorbent article capable of indicating the presence of urinary tract infections comprising:
a substantially liquid impermeable layer;
a liquid permeable layer;
an absorbent core positioned between the substantially liquid impermeable layer and the liquid permeable layer; and
a lateral flow device integrated into the article and positioned such that the device is in fluid communication with the urine when provided by a wearer of the article, the device comprising:
an aromatic primary amine that is capable of reacting with a nitrite to form a diazonium ion; and
a chromatographic medium defining a detection zone within which a detection reagent consisting of a nucleophilic aromatic amine is directly covalently bound to the chromatographic medium, the detection reagent being capable of reacting with the diazonium ion to form an indicator, the indicator exhibiting a color that is different than the color of the detection reagent.

15. The absorbent article of claim 14, wherein the aromatic primary amine comprises aniline; 4-chloroaniline; 4-bromoaniline; 2,4,6-tribromoaniline; 2,4,6-trichloroaniline; α-trifluoro-m-toluidene; ortho-toluidine; m- and p-aminophenol; ortho-tolidine; sulfanilamide, p-aminobenzoic acid; 1-amino-8-hydroxynaphthalene-3,6-disulphonic acid; aminoacetoanilide; aminophenyl ether, p-arsalinic acid; 4-amino-1-naphthalenecarbonitrile, or derivatives thereof.

16. The absorbent article of claim 14, wherein the detection reagent comprises 8-hydroxyjulolidine, N,N-dimethylaniline; methylenedianiline; benzidine; benzoquinoline; aminoquinoline; m-phenylenediamine; α-trifluoro-m-toluidene; ortho-toluidine; m-aminophenol; ortho-tolidine; N-1-naphthylethylene diamine, or a derivative thereof.

17. The absorbent article of claim 14, wherein the detection reagent comprises N-1-naphthylethylene diamine or a derivative thereof, and the detection reagent is attached to the chromatographic medium covalently by an amine bond.

18. The absorbent article of claim 14, wherein the lateral flow assay device further comprises a coupler zone within which is contained the aromatic primary amine.

19. The absorbent article of claim 14, wherein the coupler zone further comprises a surfactant.

20. The absorbent article of claim 14, wherein the lateral flow device comprises a control zone that is capable of signaling the presence of the test sample.
